(19) United States
(12) Patent Application Publication
(10) Pub. No.: US 2026/0112852 A1
(43) Pub. Date: Apr. 23, 2026

(54) CONDUCTOR CONNECTION TERMINAL

(71) Applicant: WAGO Verwaltungsgesellschaft mbH, Minden (DE)

(72) Inventor: Jan STEUSSLOFF, Sondershausen (DE)

(73) Assignee: WAGO Verwaltungsgesellschaft mbH, Minden (DE)

(21) Appl. No.: 19/362,683

(22) Filed: Oct. 20, 2025

(30) Foreign Application Priority Data
Oct. 23, 2024 (DE) 20 2024 106 083.0

(51) Int. Cl. H01R 25/14

(52) U.S. Cl. CPC H01R 25/142

(57) ABSTRACT

A conductor connection terminal with at least one first spring‑loaded clamping connection. The at least one first spring-loaded clamping connection has a first clamping spring. The conductor connection terminal also has at least one second spring-loaded clamping connection, which has a second clamping spring. A U‑shaped busbar is also provided.

This nonprovisional application claims priority under 35 U.S.C. § 119(a) to German Patent Application No. 202024106 083.0, which was filed in Germany on October 23, 2024, and which is herein incorporated by reference.

### BACKGROUND OF THE INVENTION

### FIELD OF THE INVENTION

The invention relates to a conductor connection terminal with at least one first spring‑loaded clamping connection, which has a first clamping spring, with at least one second spring-loaded clamping connection, which has a second clamping spring, and with a U-shaped busbar.

### Description of the Background Art

Conductor connection terminals with spring-loaded clamping connections are well known from practice. They enable an easily producible conductor connection of electrical conductors to a busbar to create an electrical connection and are characterized by secure contacting and convenient handling thanks to the clamping connection made possible by a clamping spring.

In tight installation environments in particular, it may be desirable to provide compact conductor connection terminals with a small space requirement. At the same time, the aim is to provide conductor connection terminals with easily accessible and easy‑to‑handle conductor connections with a high connection density.

### SUMMARY OF THE INVENTION

It is therefore an object of the present invention to provide a compact and easy-to-handle conductor connection terminal with expanded connection options.

In an example, a conductor connection terminal is proposed with at least one first spring-loaded clamping connection, which has a first clamping spring, and at least one second spring-loaded clamping connection, which has a second clamping spring, and with a U-shaped busbar, which has two side wall sections, substantially parallel to one another, and a cross-connection section connecting the side wall sections, wherein the busbar is designed as a common, continuous busbar of the first spring-loaded clamping connection and of the second spring-loaded clamping connection, wherein a first electrical conductor can be inserted in a first conductor insertion direction into the space enclosed by the side wall sections and the cross‑connection section of the busbar and can be clamped there by the first spring‑loaded clamping connection, wherein the second spring-loaded clamping connection is configured for inserting a second electrical conductor in a second conductor insertion direction, which is oriented transverse to the first conductor insertion direction.

Stated simply, a conductor connection terminal is proposed in which electrical conductors can be fed from different spatial directions onto a U-shaped busbar and fixed to it by spring-loaded clamping connections. As a result, a space-optimized arrangement of spring-loaded clamping connections on a U-shaped busbar is provided with easy handling of the conductor connection terminal, with which multiple connection options for electrical conductors can be realized on a compactly designed conductor connection terminal in a structurally simple and efficient manner. In this regard, an optimized utilization of the U‑shaped embodiment of the busbar can be achieved by contacting with electrical conductors in different conductor insertion directions. Thus, for example, a first electrical conductor can be inserted into the conductor connection terminal substantially parallel to the cross-connection section of the busbar and a further electrical conductor can be inserted at an angle to the cross-connection section of the busbar and clamped to the busbar.

A spring-loaded clamping connection can be an electromechanical conductor connection with a clamping spring, with which an electrical conductor can be clamped to a busbar of the conductor connection terminal by means of spring force. The at least one first spring‑loaded clamping connection can represent, for example, an electrical input side of the conductor connection terminal, whereas the at least one second spring-loaded clamping connection can be regarded as the electrical output side of the conductor connection terminal. A clamping spring can be a spring-elastic component of the conductor connection terminal with a function, which generates a frictional connection and which is designed to exert a contact pressure on an electrical conductor contacting the busbar at an intended clamping point. A busbar, which is also referred to as a contact piece or current bar, for example, can be a substantially rigid electrical conductor which can be made from a flat sheet metal strip, for example, and partially bent to form a defined busbar shape. In the present case, the busbar is designed as a U-shaped busbar, the U‑legs of which are formed by the side wall sections running substantially parallel to each other and the U-base of which is formed by the cross-connection section connecting the side wall sections. The U-shape of the busbar can refer to a cross-sectional shape of the busbar and thus describe in particular a profile shape of an elongated busbar. The busbar can in particular have an elongated shape, therefore, a greater lengthwise extent than the width and height extent, in order to enable, as a common, continuous busbar, a conductor connection via the at least one first spring-loaded clamping connection and a further conductor connection via the at least one second spring-loaded clamping connection on the busbar. In addition, an elongated busbar can promote improved mechanical and electrical contacting of a first electrical conductor running parallel to the cross-connection section. The side wall sections and the cross-connection section delimit an enclosed space on three sides into which a first electrical conductor can be inserted in the first conductor insertion direction, in particular substantially parallel to the cross-connection section along a lengthwise extent of the busbar, and can be fixed to the busbar by means of the first clamping spring. A second electrical conductor can be inserted into the conductor connection terminal in a second conductor insertion direction running transverse to the first conductor insertion direction, for example, through a side wall section or through the cross-connection section into the enclosed space of the busbar, and can be fixed to the busbar by means of the second clamping spring. The first conductor insertion direction and the second conductor insertion direction can be predefined, for example, by respective conductor insertion channels aligned according to the first conductor insertion direction and the second conductor insertion direction in an insulating material housing of the conductor connection terminal. A conductor insertion channel can be, for example, an at least partially cylindrical or funnel-shaped tunnel through which an electrical conductor can be guided to an intended clamping point of the electrical conductor on the busbar. A second conductor insertion direction, which runs transverse to the first conductor insertion direction, is understood to mean an angled course of the second conductor insertion direction relative to the first conductor insertion direction, which does not necessarily have to coincide with a perpendicular angle of 90°, but merely represents a defined inclination of the second conductor insertion direction relative to the first conductor insertion direction.

The busbar can have at least one through-opening in the cross-connection section and/or in at least one side wall section, through which opening the second electrical conductor can be inserted in the second conductor insertion direction for clamping to the second spring-loaded clamping connection, wherein the second electrical conductor extends through the through-opening when it is clamped to the second spring-loaded clamping connection. Accordingly, the second electrical conductor can pass through the cross-connection section or a side wall section of the busbar when clamped to the busbar by means of the second clamping spring. A compact and space-efficient design of the conductor connection terminal with a simple structural adaptation of the busbar via an integrated through-opening is enabled in this way. According to one design option, the through-opening can also form a clamping point in that an inserted second electrical conductor can mechanically contact an edge of the busbar at the through-opening and be clamped against the edge by means of the second clamping spring. If the second clamping spring is designed as a curved leaf spring with a contact leg and a clamping leg, as will be explained in more detail below with reference to a further embodiment, a further edge of the through-opening opposite the edge forming the clamping point can advantageously form a bearing edge for supporting the contact leg of the second clamping spring. Accordingly, the second clamping spring can be advantageously inserted into the through-opening and enable a clamping of a second electrical conductor, guided through the through-opening, against the busbar. According to one design option, multiple through-openings can be formed in the cross-connection section and/or in at least one side wall section of the busbar in order to realize an arrangement of multiple second spring-loaded clamping connections on the conductor connection terminal.

Multiple second spring-loaded clamping connections can be arranged one behind the other in the direction of the first conductor insertion direction. Consequently, an available connection surface of the busbar along its lengthwise extent can be utilized in a favorable manner. Depending on a specified length of the busbar, basically any arbitrarily large number of second spring-loaded clamping connections arranged one behind the other can be provided. According to an advantageous design option, exactly two spring-loaded clamping connections can be arranged one behind the other in order to obtain a compact conductor connection terminal. The second spring‑loaded clamping connections arranged one behind the other can be positioned at a predefined distance from each other to enable the secure connection of multiple second electrical conductors to the busbar without mutual interference. The predefined distance can be defined, for example, by a distance between two through-openings arranged one behind the other to receive a second electrical conductor in each case. The predefined distance can, for example, be less than one width of the cross-connection section, in particular less than half a width of the cross-connection section, wherein the width of the cross-connection section can be regarded as the direction of extension of the cross‑connection section perpendicular to the first conductor insertion direction.

Multiple second spring-loaded clamping connections can be arranged next to one another the other transverse to the first conductor insertion direction. Consequently, an available connection surface of the busbar along its width can be utilized in a favorable manner. Depending on the specified width of the busbar, any arbitrarily large number of second spring-loaded clamping connections arranged next to each other can be provided. According to an advantageous design option, exactly two spring-loaded clamping connections can be arranged next to each other in order to obtain a compact conductor connection terminal. The second spring-loaded clamping connections arranged next to each other can be positioned at a predefined distance from each other in order to enable the secure connection of multiple second electrical conductors to the busbar without mutual interference. The predefined distance can be defined, for example, by a distance between two through-openings arranged next to each other to receive a second electrical conductor. The predefined distance can be, for example, less than a quarter of the width of the cross-connection section. The predefined distance can be smaller than a predefined distance between two spring-loaded clamping connections arranged one behind the other. The embodiment described here with multiple second spring-loaded clamping connections arranged next to each other can be advantageously combined with the previously described embodiment with multiple second spring-loaded clamping connections arranged one behind the other in order to achieve an improved utilization of the available connection surface of the busbar. According to an advantageous design option, for example, two second spring-loaded clamping connections, arranged one behind the other, can be present on the busbar, next to which connections two further second spring‑loaded clamping connections arranged one behind the other are arranged. Accordingly, two consecutive double spring-loaded clamping connections can be arranged along a lengthwise section of the busbar. For example, four separate and spaced-apart through-openings can be made in the busbar for this purpose. In principle, more than two consecutive double spring-loaded clamping connections can also be arranged on the busbar.

At least two second spring-loaded clamping connections can each have their own through-opening in the busbar, which opening is surrounded by the busbar material. A defined and secure connection of multiple second electrical conductors to the busbar without mutual interference can be enabled hereby. A second clamping spring can be received in each through-opening of the second spring-loaded terminal connections. The second clamping spring can be supported on one edge of the respective through-opening and form a clamping edge with an opposite edge of the respective through-opening. Depending on the embodiment, multiple through-openings can be dimensioned substantially identical or specifically designed in different sizes in order to provide second spring-loaded clamping connections for different second electrical conductors.

At least two second spring-loaded clamping connections can have a common through-opening in the busbar, which opening is surrounded by the busbar material. In particular, two second spring-loaded clamping connections, which are arranged next to each other transverse to the first conductor insertion direction, can have a common through-opening in the busbar, which opening is surrounded by the busbar material. A more compact design and simpler manufacture of the conductor connection terminal is made possible hereby.

The first conductor insertion direction and the second conductor insertion direction can form an angle between 90° and 150°. A secure conductor connection to the first and second spring-loaded clamping connection with a compact design of the conductor connection terminal is made possible hereby. Accordingly, a second conductor insertion direction oriented transverse to the first conductor insertion direction can run substantially perpendicular to the first conductor insertion direction, but larger and therefore flatter angles are also conceivable at which a second conductor can be inserted into the conductor connection terminal in relation to the first conductor insertion direction and clamped to the busbar. The angle between the first conductor insertion direction and the second conductor insertion direction can be defined, for example, by an angle between a central longitudinal axis of a first conductor insertion channel for a first electrical conductor at the first spring-loaded clamping connection and a central longitudinal axis of a second conductor insertion channel for a second electrical conductor at the second spring-loaded clamping connection.

The busbar can have a greater lengthwise extent than the width extent, wherein the first conductor insertion direction runs along the lengthwise extent of the busbar and the second conductor insertion direction runs at an angle to the lengthwise extent of the busbar. The available connection area of an elongated busbar can be optimally utilized thereby. In particular, a first electrical conductor can be inserted parallel to the lengthwise extent of the busbar into the space enclosed by the side wall sections and the cross-connection section, whereas a second electrical conductor is inserted into the enclosed space, in particular through a side wall section or through the cross-connection section, thus passing through the busbar.

The at least one first spring-loaded clamping connection can have a tensioning bracket, mounted movably on the busbar, and a first clamping spring, designed as a compression spring and acting on the tensioning bracket, wherein the tensioning bracket is designed to form a first clamping point with the busbar and wherein the first clamping spring can be actuated by a first actuation element to open and close the first clamping point by moving the tensioning bracket. The compression spring can be designed in particular as a coil spring or disk spring. This makes it possible to provide a first spring-loaded clamping connection with a high clamping force, which is suitable for connecting electrical conductors with large nominal diameters, such as, for example, those used for high-current applications. Thus, the conductor connection terminal can be used in a high-current range. The tensioning bracket can be a component with a frame‑like basic shape. The tensioning bracket can have an actuation section for interaction with the compression spring. The tensioning bracket can have a clamping section with a bracket clamping edge that can press an inserted first electrical conductor against the busbar with the support of the compression spring acting on the tensioning bracket. In an unactuated state, the compression spring can act on the tensioning bracket in such a way that the bracket clamping edge is pretensioned in the direction of the busbar. By actuating the first actuation element in the first actuation direction, the tensioning bracket can be moved under the compressive force of the first actuation element against the preload of the compression spring in such a way that the bracket clamping edge is moved away from the busbar so that the first clamping point is opened and a first electrical conductor can be inserted or removed. By actuating the first actuation element in the second actuation direction, the compression spring and the tensioning bracket can be relieved of the pressure force of the first actuation element and the tensioning bracket can be moved back to its initial position so that the bracket clamping edge is moved towards the busbar and the first clamping point is closed. When the first actuation element is actuated in a second actuation direction, the bracket clamping edge can be moved towards the busbar by the restored preload, so that an inserted electrical conductor is clamped and held securely between the bracket clamping edge and the busbar with the support of the spring force of the compression spring. The first actuation element can be a rotatable actuating cylinder, for example, which is designed for mechanical interaction with the tensioning bracket and/or with the compression spring. For example, the rotatable actuating cylinder can be rotated in a first direction of rotation, which corresponds to a first actuation direction, in order to effect a movement of the tensioning bracket into the open position, and it can be rotated in a second direction of rotation, which is opposite to the first direction of rotation and corresponds to a second actuation direction, in order to effect a movement of the tensioning bracket into the clamping position. Depending on the embodiment, the rotatable actuating cylinder can be arranged, for example, on the tensioning bracket and/or the compression spring or at least partially lowered into the compression spring. The first actuation element can have an operating section and an actuating section. The operating section can be accessible from an actuating side of the conductor connection terminal in order to actuate the first actuation element, and the actuating section can contact the tensioning bracket and/or the compression spring in order to move them upon actuation. The operating section can have a tool receptacle, for example, a groove for a screwdriver tip, in order to be operated with a tool such as a screwdriver. For example, a first actuation element designed as a rotatable actuating cylinder can be actuated by inserting a screwdriver tip into a groove on an end face of the rotatable actuating cylinder and by rotating the screwdriver in the first or second direction of rotation.

The at least one second spring-loaded clamping connection can have a second clamping spring designed as a curved leaf spring, which has a contact leg and a clamping leg which can be moved between an open position and a clamping position and which is designed to form a second clamping point with the busbar. An easy-to-handle and compact second spring-loaded clamping connection can be formed thereby. The contact leg and the clamping leg of the second clamping spring can be connected to each other via a spring bow. The clamping leg of the second clamping spring can be moved towards the contact leg for moving into the open position and away from the contact leg for moving into the clamping position. The clamping leg can have at its free end a spring clamping edge, with which a second electrical conductor can be clamped against the busbar at the second clamping point. The second clamping spring can be inserted, for example, into a through-opening in the busbar. The through‑opening can be delimited by an edge of the busbar, which forms the second clamping point, in that the second electrical conductor is pressed against the edge by the spring clamping edge. The through-opening can have a further edge which is opposite the edge forming the second clamping point and which forms a bearing edge for supporting the contact leg of the second clamping spring. A second spring-loaded clamping connection with an easy-to-use and secure connection option for a second electrical conductor can be created hereby in a structurally simple and efficient way. In addition, the second spring-loaded clamping connection is made compact in this way, so that it is possible to realize multiple second spring-loaded clamping connections arranged next to and/or behind each other on the busbar as described above.

The at least one second spring-loaded clamping connection can have an actuation opening and/or a second actuation element which is configured for moving the clamping leg of the second clamping spring between the open position and the clamping position. As a result of this, the movement of the clamping leg can be supported by a second actuation element in order to facilitate the handling of the conductor connection terminal and to promote a secure conductor connection. The second actuation element can be a component of the conductor connection terminal and as such can be designed as an actuating lever or a push button, for example, which is accommodated in the actuation opening. Alternatively, a second actuation element separate from the conductor connection terminal can be inserted into the actuation opening, if necessary, in the sense of an additional actuating tool, such as, for example, a screwdriver. The actuation opening can be made in a second insulating material housing section surrounding the second spring-loaded clamping connection and positioned in such a way that the clamping leg of the second clamping spring can be reached through the actuation opening by means of the second actuation element. The second actuation element, if it is designed as a component of the conductor connection terminal, can have an operating section and an actuating section. The operating section can be accessible from the outside in order to actuate the second actuation element, and the actuating section can contact the clamping leg of the second clamping spring in order to move it upon actuation. The operating section can have a tool receptacle, for example, a groove for a screwdriver tip, in order to be operated with a tool such as a screwdriver. The operating section can be accessible from the actuating side of the conductor connection terminal in order to actuate the second actuation element. The actuation opening can be accessible from the actuating side of the conductor connection terminal in order to be able to insert a separate second actuation element into the actuation opening. Accordingly, the first actuation element and the second actuation element and/or the actuation opening can be positioned on the same actuating side of the conductor connection terminal, which further optimizes the handling of the conductor connection terminal.

The conductor connection terminal can have an insulating material housing, wherein the at least one first spring-loaded clamping connection is disposed in a first insulating material housing section with a first conductor insertion channel and the at least one second spring-loaded clamping connection is disposed in a second insulating material housing section with a second conductor insertion channel. Consequently, the handling of the conductor connection terminal is facilitated and a targeted insertion of a first electrical conductor in the first conductor insertion direction and of a second electrical conductor in the second conductor insertion direction transverse to the first conductor insertion direction is ensured. In particular, the second insulating material housing section can have multiple second conductor insertion channels depending on a number of second spring-loaded clamping connections. The insulating material housing can be designed for the electrically insulating receiving of a contact insert with the busbar, the at least one first spring-loaded clamping connection, and the at least one second spring-loaded clamping connection.

The busbar can have a first busbar section, in which the at least one first spring-loaded clamping connection is disposed, and a second busbar section, in which the at least one second spring-loaded clamping connection is disposed, wherein the busbar is at least partially widened in the second busbar section. In other words, a distance between the side wall sections of the busbar in the second busbar section can be greater, at least in some areas, than in the first busbar section. Such a partial widening can be achieved, for example, by a local bulge in a side wall section or by two opposing local bulges in the side wall sections, wherein the bulges are designed in such a way that they partially enlarge the enclosed space between the side wall sections and the cross-connection section. Such a bulge can be produced, for example, by local embossing of the side wall section or side wall sections. With a partially widened second busbar section, a local increase in installation space can be achieved in the connection area of the busbar in order to enable or optimize the accommodation of multiple second spring-loaded clamping connections next to each other in the cross‑connection section. In this way, for example, standardized second clamping springs with predefined dimensions can also be placed next to each other on the busbar without further adjustment. The bulge can, for example, be adjacent to a through-opening in the cross-connection section. A partial widening of the busbar limited to the second busbar section can ensure that a first electrical conductor is securely received and clamped in the first busbar section with a busbar contour that is matched to the first spring-loaded clamping connection.

The at least one first spring-loaded clamping connection can be configured to connect electrical conductors with a nominal cross section of at least 20 mm², in particular between 25 and 95 mm². As a result, electrical conductors with large nominal diameters, such as, for example, those used for high-current applications, can be connected to the busbar using the first spring-loaded clamping connection. Thus, the conductor connection terminal can be used in a high-current range. For such a first spring‑loaded clamping connection, the busbar can be designed in particular in such a way that the side wall sections and the cross-connection section enclose a space with a cross-sectional area that can accommodate an electrical conductor with a nominal cross section of at least 20 mm². In addition, the first spring-loaded clamping connection can be designed according to the previously described embodiment, in which the first spring‑loaded clamping connection has a tensioning bracket and a first clamping spring designed as a compression spring, so that a sufficiently large clamping force can be generated at the first spring-loaded clamping connection.

The at least one second spring-loaded clamping connection can be configured to connect electrical conductors with a nominal cross section of a maximum of 20 mm², in particular between 0.5 and 16 mm². By designing the second spring-loaded clamping connection for smaller nominal electrical conductor diameters, it is possible to construct the second spring-loaded clamping connections compactly and to arrange a plurality of second spring-loaded clamping connections on the busbar, for example, one behind the other and/or side by side transversely thereto as seen along the first conductor insertion direction. For such a second spring-loaded clamping connection, this can be designed, for example, according to the previously described embodiment, in which the second spring-loaded clamping connection has a second clamping spring designed as a curved leaf spring. With such simply designed and inexpensively produced clamping springs, electrical conductors with nominal cross sections of up to 20 mm² can be reliably clamped to the busbar.

The conductor connection terminal can have a mounting rail securing element for securing the conductor connection terminal to a mounting rail. As a result, the conductor connection terminal can be secured to a mounting rail in a simple and easy-to-handle manner. The mounting rail securing element can be designed, for example, as a latching element with which the conductor connection terminal can be detachably latched onto the mounting rail. The conductor connection terminal can also be designed as a PE conductor connection terminal with an electrically conductive connection to the mounting rail.

The conductor connection terminal can also have a surface fastening element for fastening the conductor connection terminal to an object surface. The conductor connection terminal can be fastened hereby to an object surface, for example, a device surface, in a simple and easy-to-handle manner. The surface fastening element can be designed as a fastening flange, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor connection terminal according to one embodiment in a sectional front view;

FIG. 2 shows the conductor connection terminal according to FIG. 1 in a perspective front view with a sectional view of an insulating material housing of the conductor connection terminal;

FIG. 3 shows a contact insert for a conductor connection terminal according to FIG. 1 with a busbar and first and second spring-loaded clamping connections arranged thereon in a perspective front view;

FIG. 4 shows the contact insert according to FIG. 3 in a front view;

FIG. 5 shows the contact insert according to FIG. 3 in a side view, without showing the first spring-loaded clamping connection; and

FIG. 6 shows an isolated representation of the busbar of the contact insert according to FIG. 3 in a perspective top view.

### DETAILED DESCRIPTION

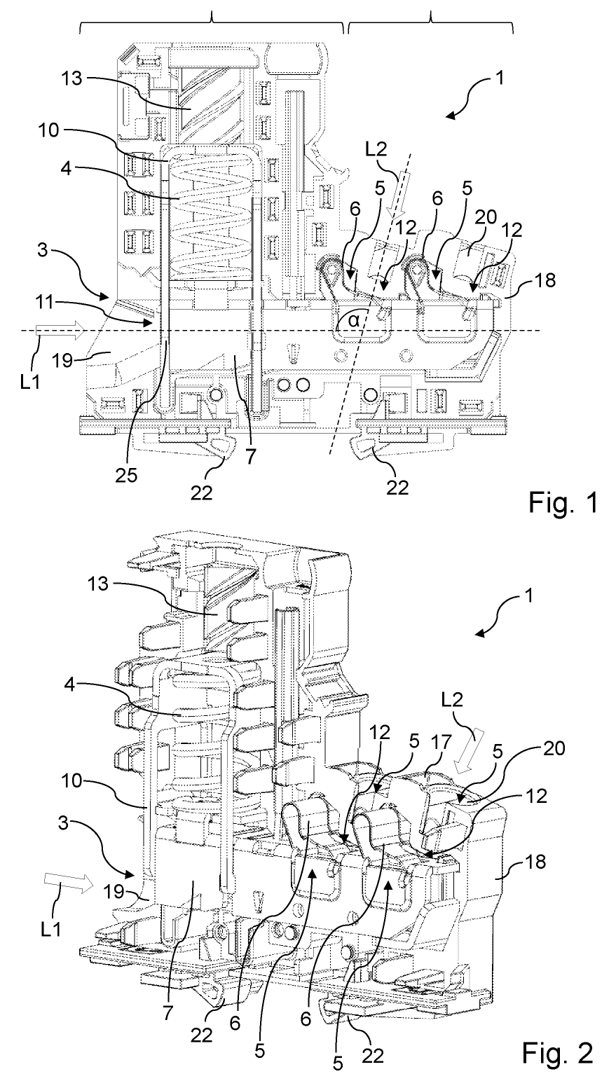

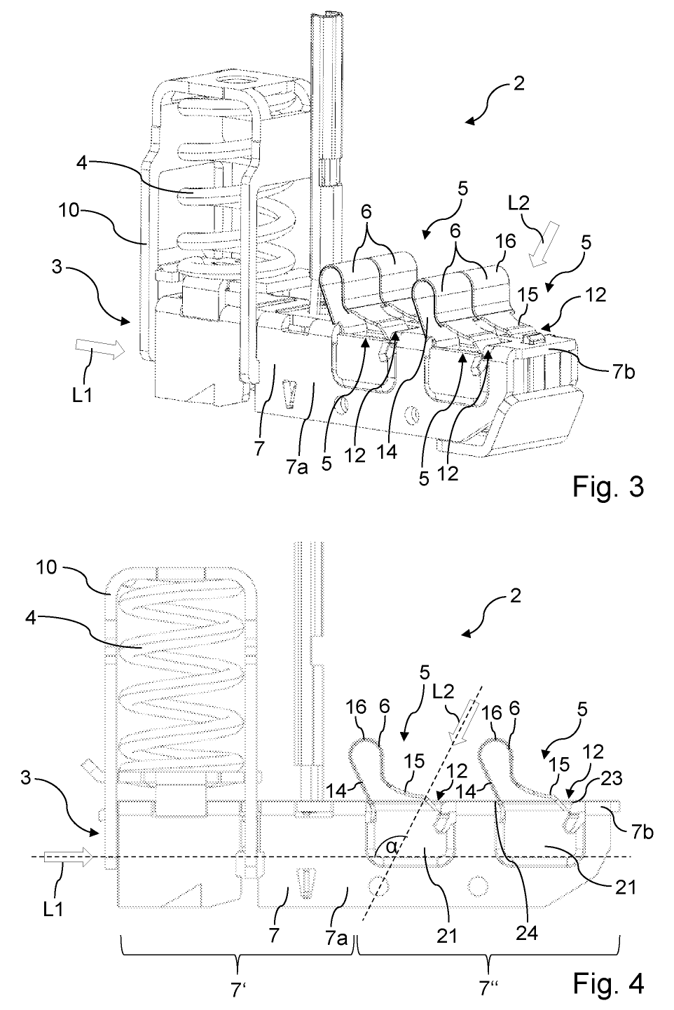

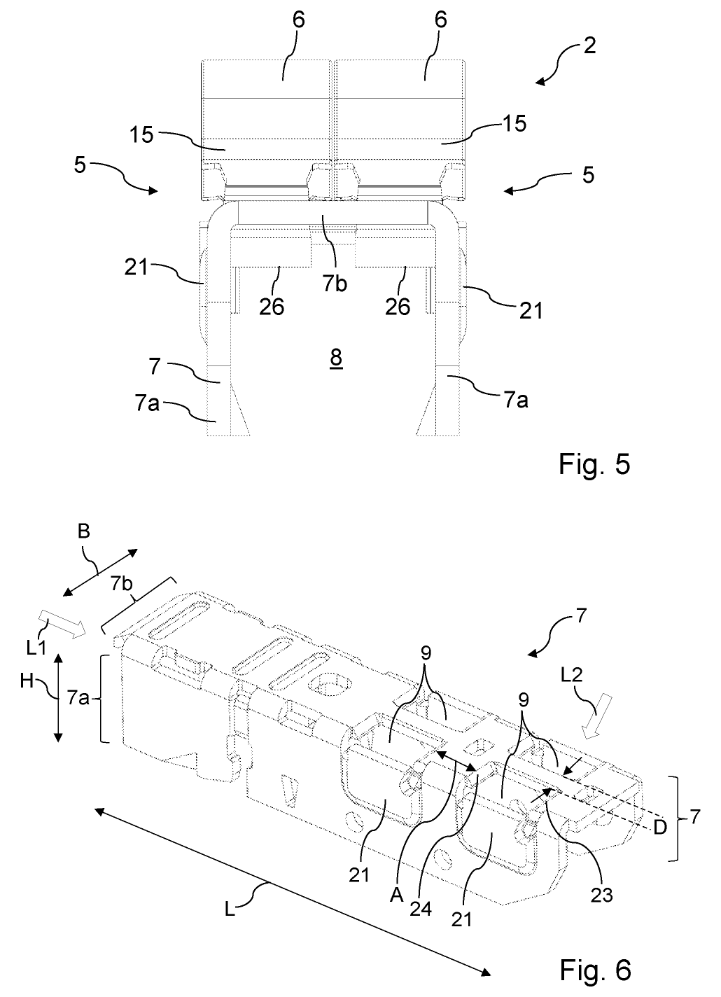

FIGS. 1 to 6 show a conductor connection terminal 1 according to one embodiment in different views. Conductor connection terminal 1 has a U-shaped busbar 7, on which a first spring-loaded clamping connection 3 with a first clamping spring 4 and, as shown, a plurality of four second spring-loaded clamping connections 5 with second clamping springs 6 are arranged. Busbar 7 is designed as a common, continuous busbar 7 of first spring-loaded clamping connection 3 and multiple second spring-loaded clamping connections 5. FIGS. 1 and 2 show partially sectional views of conductor connection terminal 1. FIGS. 3 and 4 show an isolated representation of busbar 7 with first spring‑loaded clamping connection 3 and multiple second spring-loaded clamping connections 5, which form a contact insert 2 for conductor connection terminal 1. An isolated representation of busbar 7 can be seen in FIGS. 5 and 6, where FIG. 5 additionally shows second spring-loaded clamping connections 5 on busbar 7.

As can be seen in FIGS. 3 to 6, for example, the U-shaped busbar has two side wall sections 7a that are substantially parallel to each other and a cross-connection section 7b that connects the side wall sections 7a. It is made clear in FIG. 5 that side wall sections 7a and cross-connection section 7b enclose a space 8 by delimiting it from three sides. For example, FIGS. 1 and 2 show that a first electrical conductor (not shown in detail) can be inserted in a first conductor insertion direction L1 into space 8 of busbar 7 enclosed by side wall sections 7a and cross-connection section 7b and can be clamped there by means of the spring-loaded clamping connection 3.

Furthermore, it can be seen in FIGS. 1 and 2, for example, that second spring-loaded clamping connections 5 are configured for inserting second electrical conductors (not shown in detail) in a second conductor insertion direction L2, wherein second conductor insertion direction L2 is oriented transverse to first conductor insertion direction L1. Accordingly, electrical conductors can be fed to busbar 7 from different directions and fixed to it in different orientations, which makes it possible to provide a compact conductor connection terminal 1 with a high connection density. As illustrated in FIGS. 1 and 4, first conductor insertion direction L1 and second conductor insertion direction L2 can form, for example, an angle α between 90° and 150°, so that second electrical conductors can be moved towards busbar 7 and clamped to it not necessarily at right angles, but, for example, also at flatter angles α.

According to FIG. 1, conductor connection terminal 1 has an insulating material housing 18 with a first insulating material housing section 18a, in which first spring-loaded clamping connection 3 is disposed, and a second insulating material housing section 18b, in which second spring-loaded clamping connections 5 are disposed. A first conductor insertion channel 19 is disposed in first insulating material housing section 18a, which channel facilitates an insertion of a first electrical conductor into space 8 enclosed by busbar 7 in first conductor insertion direction L1. Four second conductor insertion channels 20 are disposed in second insulating material housing section 18a, which channels facilitate an insertion of second electrical conductors into space 8 enclosed by busbar 7 in second conductor insertion direction L2. As can be seen in FIGS. 1 and 2, mounting rail securing elements 22 designed as latching elements can be disposed on insulating material housing 18 for securing conductor connection terminal 1 to a mounting rail. Alternatively or in addition, it is conceivable to provide conductor connection terminal 1 with surface fastening elements for fastening conductor connection terminal 1 to an object surface.

Each second clamping spring 6 is inserted into a respective through-opening 9 in cross‑connection section 7b, as shown in FIG. 6, for example. Alternatively, it is conceivable that a side wall section 7a of busbar 7 has a through-opening 9 for a second clamping spring 6 or that at least two second clamping springs 6, in particular two second clamping springs 6 arranged next to each other transverse to first conductor insertion direction L1, are inserted into a common through-opening 9 in busbar 7. Through-openings 9 are each surrounded by the material of busbar 7. A second electrical conductor can be inserted into each through-opening 9 in second conductor insertion direction L2 and clamped to busbar 7 by means of second clamping spring 6, so that the second electrical conductor extends through through-opening 9 when it is clamped to second spring-loaded clamping connection 5. Accordingly, the second electrical conductors can reach through busbar 7, in particular through cross-connection section 7b or side wall section 7a of busbar 7, whereby a space-efficient realization of the second spring-loaded clamping connections 5 is possible. As becomes apparent from FIGS. 4 and 6, for example, through-opening 9 can also form a second clamping point 12, in that an inserted second electrical conductor can be clamped against an edge 23 of busbar 7 at through-opening 9.

FIGS. 2 and 3, for example, show that two second spring-loaded clamping connections 5 are arranged one behind the other in the direction of first conductor insertion direction L1 and two second spring-loaded clamping connections 5 are arranged next to each other at right angles to first conductor insertion direction L1. Accordingly, as shown, two double spring-loaded clamping connections 5, one following the other in the longitudinal direction L of busbar 7, can be provided in conductor connection terminal 1. As a result, a generally available connection surface of busbar 7 can be optimally utilized along its lengthwise extent L and its width extent B, as shown in FIG. 6, with the conductor connection terminal 1 still remaining compact. Second spring-loaded clamping connections 5 arranged next to each other can be spaced apart by a predefined distance D as illustrated in FIG. 6. Second spring-loaded clamping connections 5 arranged one behind the other can be spaced apart by a predetermined distance A as illustrated in FIG. 6. The specified distance can be greater, for example, at least twice as great as the predefined distance D. The specified distance A and the predefined distance D can be smaller than a width B of busbar 7, in particular than half a width B of busbar 7.

FIGS. 1 and 2 show that first spring-loaded clamping connection 3 has a tensioning bracket 10, mounted movably on busbar 7, and a first clamping spring 4, acting on tensioning bracket 10 and designed as a compression spring, in this case as a helical spring. Tensioning bracket 10 is designed to form a first clamping point 11 with busbar 7. First clamping spring 4 can be actuated by a first actuation element 13 to open and close first clamping point 11 by moving tensioning bracket 10. With such a first spring-loaded clamping connection 3, electrical conductors with large nominal diameters can be securely clamped to busbar 7 so that conductor connection terminal 1 is suitable for a high-current range, for example. FIG. 1 illustrates that tensioning bracket 10 has a bracket clamping edge 25, with which an inserted first electrical conductor can be clamped against busbar 7 with the support of first clamping spring 4, which is designed as a helical spring. First clamping spring 4 can pretension the bracket clamping edge 25 in the direction of busbar 7. As illustrated in FIGS. 1 and 2, first actuation element 13 is designed as a rotatable actuating cylinder and is configured for mechanical interaction with first clamping spring 4 and tensioning bracket 10, on which the rotatable actuating cylinder is arranged.

FIGS. 1 and 2 also show that second spring-loaded clamping connections 5 each have a second clamping spring 6 designed as a curved leaf spring. It can be seen in FIGS. 3 and 4 that second clamping springs 6 each have a contact leg 14 and a clamping leg 15 that can be moved between an open position and a clamping position, wherein contact leg 14 and clamping leg 15 are connected to each other via a spring bow 16. In this regard, each clamping leg 15 is designed to form a second clamping point 12 at an edge 23 of busbar 7 as shown in FIGS. 4 and 6. For this purpose, clamping leg 15 has a spring clamping edge 26, illustrated in FIG. 5, with which the second electrical conductor can be clamped against edge 23. As shown in FIGS. 4 and 6, contact leg 14 can be supported on a bearing edge 24 opposite edge 23. In this way, second spring-loaded terminal connections 5 can provide secure and easy-to-handle connection options for second electrical conductors in a structurally simple manner. Second spring-loaded clamping connections 5 can each have a second actuation element (not shown in detail), which is configured to move clamping leg 15 of the respective second clamping spring 6 between the open position and the clamping position. FIG. 2 shows an example of an actuation opening 17 for a second actuation element designed as a handle. Actuation opening 17 can alternatively form an access for a second actuation element which is separate from conductor connection terminal 1 and which can be designed as a screwdriver, for example, and be suitable for moving clamping leg 15.

It can be seen in FIG. 4 that busbar 7 has a first busbar section 7' in which first spring‑loaded clamping connection 3 is disposed. In addition, busbar 7 has a second busbar section 7'' in which the second spring-loaded clamping connections 5 are disposed. In this case, as can also be seen in FIGS. 5 and 6, for example, busbar 7 has a bulge 21 in side wall sections 7a at each second spring-loaded clamping connection 5, by means of which busbar 7 is partially widened in second busbar section 7". Bulges 21 are adjacent to through-openings 9 of second spring-loaded clamping connections 5. A bulge 21 can be produced, for example, by local embossing of busbar 7 in its side wall sections 7a. The partial widening can create additional space for accommodating second clamping springs 6 arranged next to each other.

FIG. 6 illustrates that busbar 7 has a lengthwise extent L, a width extent B, and a height extent H. According to the exemplary embodiment shown in the figures, busbar 7 has a greater lengthwise extent L than a width extent B, so that an elongated busbar 7 is formed. In conjunction with FIGS. 1 to 4, it is clear that first conductor insertion direction L1 runs along the lengthwise extent L of busbar 7 and second conductor insertion direction L2 runs at an angle to the lengthwise extent L of busbar 7.

First spring-loaded clamping connection 3 can be configured to connect electrical conductors with a nominal cross section of at least 20 mm², in particular between 25 and 95 mm², in order to be able to connect electrical conductors with large nominal diameters to busbar 7 and to use conductor connection terminal 1 for high-current applications, for example. Second spring-loaded clamping connections 5 can each be configured to connect electrical conductors with a maximum nominal cross section of 20 mm², in particular between 0.5 and 16 mm², in order to be able to realize a high connection density on the compact conductor connection terminal 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor connection terminal comprising:
at least one first spring-loaded clamping connection, which has a first clamping spring;
at least one second spring-loaded clamping connection, which has a second clamping spring; and
a U-shaped busbar that has two side wall sections substantially parallel to one another and a cross-connection section connecting the side wall sections,
wherein the busbar is designed as a common, continuous busbar of the first spring-loaded clamping connection and of the second spring-loaded clamping connection,
wherein a first electrical conductor is adapted to be inserted in a first conductor insertion direction into a space enclosed by the side wall sections and the cross-connection section of the busbar and is adapted to be clamped there by the first spring‑loaded clamping connection, and
wherein the second spring-loaded clamping connection is configured for inserting a second electrical conductor in a second conductor insertion direction, which is oriented transverse to the first conductor insertion direction.

2. The conductor connection terminal according to claim 1, wherein the busbar has at least one through-opening in the cross-connection section and/or in at least one side wall section, through which opening the second electrical conductor is adapted to be inserted in the second conductor insertion direction to clamp to the second spring-loaded clamping connection, and wherein the second electrical conductor extends through the through-opening when it is clamped to the second spring-loaded clamping connection.

3. The conductor connection terminal according to claim 1, wherein at least two second spring-loaded clamping connections are arranged one behind the other in a direction of the first conductor insertion direction.

4. The conductor connection terminal according to claim 1, wherein at least two second spring-loaded clamping connections are arranged next to one another transverse to the first conductor insertion direction.

5. The conductor connection terminal according to claim 1, wherein at least two second spring-loaded clamping connections each have their own through‑opening in the busbar, which opening is surrounded by the material of the busbar.

6. The conductor connection terminal according to claim 1, wherein at least two second spring-loaded clamping connections have a common through‑opening in the busbar, which opening is surrounded by the material of the busbar.

7. The conductor connection terminal according to claim 1, wherein the first conductor insertion direction and the second conductor insertion direction form an angle between 90° and 150°.

8. The conductor connection terminal according to claim 1, wherein the busbar has a greater lengthwise extent than a width extent, and wherein the first conductor insertion direction runs along the lengthwise extent of the busbar and the second conductor insertion direction runs at an angle to the lengthwise extent of the busbar.

9. The conductor connection terminal according to claim 1, wherein the at least one first spring-loaded clamping connection has a tensioning bracket mounted movably on the busbar, and has a first clamping spring designed as a compression spring and acting on the tensioning bracket, wherein the tensioning bracket forms a first clamping point with the busbar, and wherein the first clamping spring is adapted to be actuated by a first actuation element to open and close the first clamping point by moving the tensioning bracket.

10. The conductor connection terminal according to claim 1, wherein the at least one second spring-loaded clamping connection has a second clamping spring designed as a curved leaf spring, which has a contact leg and a clamping leg that is adapted to be moved between an open position and a clamping position and which is designed to form a second clamping point with the busbar.

11. The conductor connection terminal according to claim 10, wherein the at least one second spring-loaded clamping connection has an actuation opening and/or a second actuation element that is configured for moving the clamping leg of the second clamping spring between the open position and the clamping position.

12. The conductor connection terminal according to claim 1, wherein the conductor connection terminal has an insulating material housing, wherein the at least one first spring-loaded clamping connection is disposed in a first insulating material housing section with a first conductor insertion channel and the at least one second spring-loaded clamping connection is disposed in a second insulating material housing section with a second conductor insertion channel.

13. The conductor connection terminal according to claim 1, wherein the busbar has a first busbar section, in which the at least one first spring-loaded clamping connection is disposed, and a second busbar section, in which the at least one second spring-loaded clamping connection is disposed, and wherein the busbar is at least partially widened in the second busbar section.

14. The conductor connection terminal according to claim 1, wherein the at least one first spring-loaded clamping connection is configured to connect electrical conductors with a nominal cross section of at least 20 mm², or between 20 and 95. mm².

15. The conductor connection terminal according to claim 1, wherein the at least one second spring-loaded clamping connection is configured to connect electrical conductors with a nominal cross section of a maximum of 20 mm², or between 0.5 and 16 mm².

16. The conductor connection terminal according to claim 1, wherein the conductor connection terminal has a mounting rail securing element for securing the conductor connection terminal to a mounting rail.

17. The conductor connection terminal according to claim 1, wherein the conductor connection terminal has a surface fastener to fasten the conductor connection terminal to an object surface.
